(19) United States
(12) Patent Application Publication
(10) Pub. No.: US 2016/0308193 A1
(43) Pub. Date: Oct. 20, 2016

(54) NONAQUEOUS ELECTROLYTE SECONDARY BATTERY

(71) Applicant: SANYO ELECTRIC CO., LTD., Daito-shi, Osaka (JP)

(72) Inventors: Shinya Miyazaki, Hyogo (JP); Hiroki Watanabe, Hyogo (JP)

(73) Assignee: SANYO Electric Co., Ltd., Daito-shi, Osaka (JP)

(21) Appl. No.: 14/909,810

(22) PCT Filed: Sep. 8, 2014
(86) PCT No.: PCT/JP2014/004594

§ 371 Date: Feb. 3, 2016

(30) Foreign Application Priority Data
Sep. 17, 2013 (JP) 2013-191419

(51) Int. Cl. H01M 4/131; H01M 10/0585; H01M 4/505; H01M 10/0525; H01M 4/62; H01M 4/525

(52) U.S. Cl. CPC H01M 4/131; H01M 4/625; H01M 4/525; H01M 4/505; H01M 10/0525; H01M 10/0585; H01M 2004/028

(57) ABSTRACT

A nonaqueous electrolyte secondary battery according to the present invention includes a positive electrode mixture which contains a positive electrode active material having a particle diameter of 10 μm or less and containing a main material represented by a composition formula Liₐ(Ni_{b}Co_{c}Mn_{d})_{1-x-y}ZrₓM_{y}O₂ (wherein a=1.10±0.05, 0.3≦b≦0.5, 0.3≦c≦0.5, d=1, 0.001≦x≦0.01, 0≦y≦0.1, and M is an element selected from Ti, Nb, Mo, Zn, Al, Sn, Mg, Ca, Sr, and W), and acetylene black as a conductive agent which has a specific surface area of 25 m kg or more and 50 m²/q or less determined by a BET method; and the filling density of the positive electrode active material in the positive electrode mixture is 3.5 g/cm³ or less.

### TECHNICAL FIELD

The present invention relates to a nonaqueous electrolyte secondary battery.

### BACKGROUND ART

Nonaqueous electrolyte secondary batteries represented by lithium ion batteries are used in various applications such as a power supply of a cellular phone, power supplies of an electric tool, an electric car, an electric bike, an electric assisted bicycle, etc., a backup power supply, and the like. With increasing use of devices provided with nonaqueous electrolyte secondary batteries, further improvement in characteristics of the nonaqueous electrolyte secondary batteries is strongly required by the users of the devices.

Lithium cobaltate has commonly been used as a positive electrode active material of a nonaqueous electrolyte secondary battery. However, when a positive electrode using lithium cobaltate is exposed to a high potential for a long time, cobalt elution into an electrolyte occurs, thereby causing deterioration in battery characteristics. Therefore, a lithium composite oxide containing nickel which is low cost and considered to be excellent in charge/discharge cycle characteristics and storage characteristics has recently attracted attention, and the research and development thereof has been advanced. For example, Patent Literatures 1 and 2 disclose nonaqueous electrolyte secondary batteries using a so-called ternary lithium composite oxide containing nickel, cobalt, and manganese, and further containing a small amount of an element other than the three elements. These literatures describe that charge/discharge cycle characteristics and storage characteristics are improved by using the oxide as a positive electrode material.

Improvement in a positive electrode active material is advanced, while with attention given to a conductive agent to be mixed for producing a positive electrode mixture, investigation is performed to improve battery characteristics by improving the dispersion state of the conductive agent in the positive electrode mixture, the impregnation state of an electrolyte in the positive electrode mixture, and decomposition of the electrolyte with the conductive agent. For example, Literatures 3 to 5 describe that carbon black or acetylene black having a relatively small BET specific surface area is used as the conductive agent.

### CITATION LIST

### Patent Literature

PTL 1: Japanese Published Unexamined Patent Application No. 2006-202647

PTL 2: Japanese Published Unexamined Patent Application No. 2012-28313

PTL 3: Japanese Published Unexamined Patent Application No. 2004-207034

PTL 4: Japanese Published Unexamined Patent Application No. 2006-185792

PTL 5: Japanese Published Unexamined Patent Application No. 2012-221684

### SUMMARY OF INVENTION

### Technical Problem

The characteristics of a nonaqueous electrolyte secondary battery include a battery capacity, charge/discharge cycle characteristics, and storage characteristics, and the like. Battery engineers attempt to achieve optimum battery characteristics by adjusting the physical properties of the electrode materials described above or an electrolyte, a separator, and the like and by sometimes using a novel material. However, when an active material is incorporated at a high density into an electrode in order to obtain a high capacity, the load characteristic and charge/discharge cycle characteristics of a battery are degraded due to breakage of active material particles and deterioration in conductivity of an electrode plate, or storage characteristics are degraded by undesired reaction. Also, an electrode plate becomes hard and hard to bend, thereby causing difficulty in forming a wound electrode body. In order to improve the load characteristic, the battery reaction rate is increased by decreasing the particle diameters of the electrode active material and the conductive agent, while in order to improve the storage characteristics, undesired reaction with an electrolyte is suppressed by conversely increasing the particle diameters of the electrode active material and the conductive agent. In this way, engineers have taken great pains to satisfy a plurality of battery characteristics which appear not to be simultaneously satisfied, but such simultaneous satisfaction is very difficult to realize.

Accordingly, from the findings obtained by various experiments, the inventors found a configuration which satisfies both the contradictory battery characteristics, leading to the achievement of the present invention. That is, an object of the present invention is to provide a nonaqueous electrolyte secondary battery which can satisfy excellent charge/discharge cycle characteristics and high-temperature storage characteristics.

### Solution to Problem

In order to solve the problem described above, a nonaqueous electrolyte secondary battery of the present invention includes a positive electrode containing a positive electrode mixture, a negative electrode, a separator which insulates between the positive electrode and the negative electrode, and a nonaqueous electrolyte, wherein the positive electrode mixture contains a positive electrode active material having a particle diameter of 10 μm or less and containing a main material represented by a composition formula Liₐ(Ni_{b}Co_{c}Mn_{d})_{1-x-y}ZrₓM_{y}O₂ (wherein a=1.10±0.05, 0.3≦b≦0.5, 0.3≦c≦0.5, b+c+d=1, 0.001≦x≦0.01, 0≦y≦0.1, and M is an element selected from Ti, Nb, Mo, Zn, Al, Sn, Mg, Ca, Sr, and W) and acetylene black as a conductive agent which has a specific surface area of 25 m²/g or more and 50 m²/g or less determined by a BET method, and the filling density of the positive electrode active material is 3.5 g/cm³ or less.

In the present invention, the particle diameter represents the particle diameter of secondary particles.

Also, in the nonaqueous electrolyte secondary battery, the filling density of the positive electrode active material is more preferably 3.0 g/cm³ or more.

Further, the nonaqueous electrolyte secondary battery preferably includes the positive electrode ad the negative electrode both having a flat-plate shape and uses a laminated electrode body formed by alternately laminating a plurality of flat plates and a plurality of flat-plate-shaped negative electrodes through separators.

### Advantageous Effects of Invention

By configuring a nonaqueous electrolyte secondary battery as described above, it is possible to provide a nonaqueous electrolyte secondary battery capable of simultaneously satisfying excellent charge/discharge cycle characteristics and high-temperature storage characteristics.

### BRIEF DESCRIPTION OF DRAWINGS

FIG. 1 is a perspective view of a nonaqueous electrolyte secondary battery according to an embodiment of the present invention.

FIG. 2 is a perspective view of a laminated electrode body used in a nonaqueous electrolyte secondary battery according to an embodiment of the present invention.

### DESCRIPTION OF EMBODIMENTS

An embodiment for carrying out the present invention is described on the basis of the drawings. The present invention is not limited to the embodiment described below, and can be carried out with appropriate changes within a range not changing the gist of the present invention.

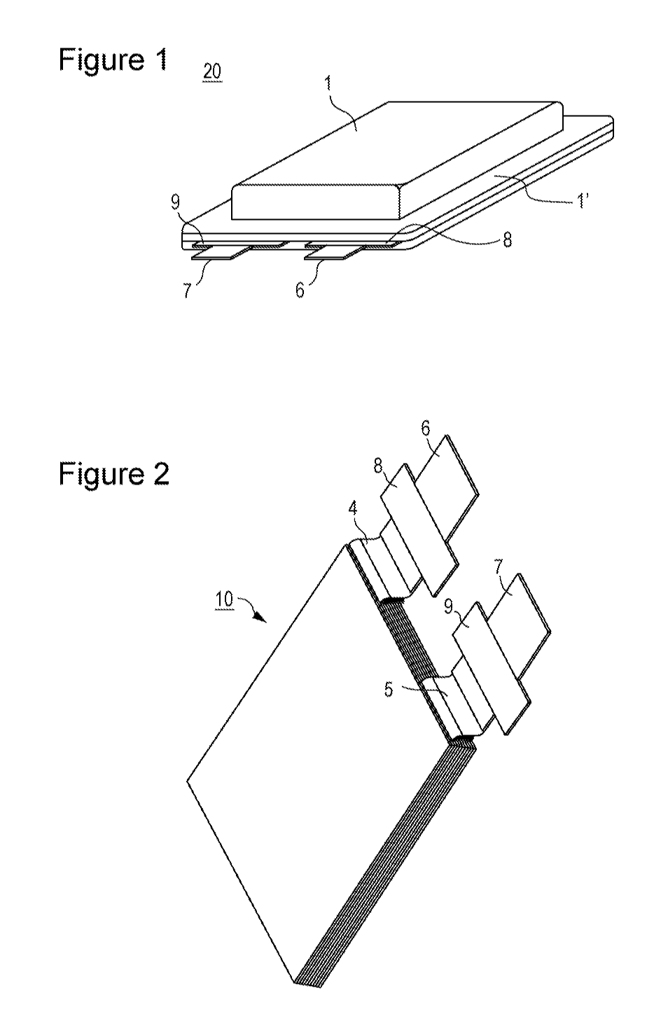

FIG. 1 is a perspective view of a nonaqueous electrolyte secondary battery according to an embodiment of the present invention. FIG. 2 is a perspective view of a laminated electrode body used in the nonaqueous electrolyte secondary battery shown in FIG. 2.

### Embodiment

As shown in FIG. 1, a nonaqueous electrolyte secondary battery 20 according to an embodiment of the present invention includes a laminated electrode body 10 described below which is contained together with a nonaqueous electrolyte in an external body 1 including a laminate sheet formed by laminating resin films on both surfaces of a metal foil. The external body 1 has two portions not shown in the drawing and including a cup-shaped portion and a plane-shaped portion. The laminated electrode body and the nonaqueous electrolyte are contained in the cup-shaped portion, the opening of the cup is covered with the plane-shaped portion, and the cup portion and the plane-shaped portion are weld-sealed with a weld-sealing portion 1′ at the peripheral edge.

In addition, a positive electrode terminal 6 and a negative electrode terminal 7 project from one side of the weld-sealing portion 1′. The positive electrode terminal 6 and the negative electrode terminal 7 are connected to a positive electrode current collector tab 4 and a negative electrode current collector tab 5, respectively, of the laminated electrode body 1 described below. A positive electrode tab resin 8 and a negative electrode tab resin 9 are disposed between the external body 1 and the positive electrode terminal 6 and the negative electrode terminal 7, respectively. The positive electrode tab resin 8 and the negative electrode tab resin 9 improve the adhesion between the laminate sheet of the external body 1 and the positive electrode terminal 6 and between the laminate sheet of the external body 1 and the negative electrode terminal 7, respectively. Further, short-circuiting is prevented between the metal foil of the laminate sheet of the external body 1 and the positive electrode terminal 6 and between the metal foil of the laminate sheet of the external body 1 and the negative electrode terminal 7.

As shown in FIG. 2, the laminated electrode body 10 contained in the nonaqueous electrolyte secondary battery 20 includes a plurality of flat-plate-shaped positive electrode plates and a plurality of flat-plate-shaped negative electrode plates which are alternately laminated through separators. Each of the positive electrode plates has a rectangular aluminum foil having both surfaces coated with a positive electrode mixture. Also, each of the positive electrode plates has the positive electrode collector tab 4 including an aluminum foil projecting from a rectangular portion not coated with the positive electrode mixture. Each of the negative electrode plates has a rectangular copper foil having both surfaces coated with a negative electrode mixture. Also, each of the negative electrode plates has the negative electrode collector tab 5 including a copper foil projecting from a rectangular portion not coated with the negative electrode mixture.

After the electrode plates are laminated, the positive electrode current collector tabs 4 projecting from the respective positive electrode plates are bundled and connected to the positive electrode terminal 6. Similarly, the negative electrode current collector tabs 5 are bundled and connected to the negative electrode terminal 7.

In the laminated electrode body described above, the positive electrode plates and the negative electrode plates need not be bent when the electrode body is formed, and thus even when the electrode plates become hard by filling the electrode plates with an active material at a high density, winding of the electrode plates causes no defects such as cutting due to breakage of the electrode plates. When the positive electrode plates are filled at a high density with the positive electrode active material used in the present invention, the positive electrode plates are easily hardened. Therefore, the positive electrode plates using the positive electrode active material are preferably used in the laminated electrode body.

The method for producing the nonaqueous electrolyte secondary battery is described in further detail.

### Example 1

### Preparation of Positive Electrode Active Material

Sodium hydrogen carbonate was added to a sulfuric acid solution containing metal ions so that the final composition of a positive electrode active material had a nickel:cobalt:manganese molar ratio of 0.3:0.4:0.3 to co-precipitate a carbonate salt containing nickel, cobalt, and manganese. The carbonate salt was thermally decomposed by heating to produce an oxide containing nickel, cobalt, and manganese. Then, the oxide was mixed with zirconium oxide so that the final composition of the positive electrode active material had a (total of nickel, cobalt, and manganese):zirconium molar ratio of 0.995:0.005 and further mixed with lithium carbonate as a lithium source so that the final composition of the positive electrode active material had a (total of nickel, cobalt, manganese, and zirconium):lithium molar ratio of 1:1.10. The resultant mixture was fired in air at 850° C. and then crushed to produce lithium-nickel-cobalt-manganese composite oxide containing zirconium and having a particle diameter of 8 μm. The particle diameter can be increased by increasing the heating decomposition temperature or the firing temperature and decreased by decreasing the temperature.

The composition of the positive electrode active material was determined by analysis using plasma emission spectrometry. The particle diameter was a particle diameter at cumulative particle amount of 50% by volume determined from the values of measurement using a laser diffraction grain size distribution measuring apparatus.

### Formation of Positive Electrode

First, 94.5 parts by mass of the produced lithium/nickel/cobalt/manganese composite oxide containing zirconium and 3 parts by mass of acetylene black as a conductive agent having a specific surface area of 40 m²/g were mixed, and further the resultant mixture and 2.5 parts by mass of polyvinylidene fluoride as a binder were dispersed in N-methyl-2-pyrrolidone (NMP) to prepare a positive electrode mixture slurry. The slurry was uniformly applied, by a doctor blade method, to both surfaces of a positive electrode core including an aluminum foil having a thickness of 15 μm as the positive electrode body. The slurry applied on the aluminum foil was dried by heating to form a dry electrode plate having a positive electrode mixture layer formed on the aluminum foil. The dry electrode plate was compressed by a roller press machine and then cut into predetermined dimensions to form a positive electrode plate having a height of 150 mm, a width of 150 mm, a thickness of 130 μm, and an active material filling density of 3.25 g/cm³. In addition, the positive electrode current collector tab 4 including only an aluminum foil having a width of 30 mm and a height of 20 mm was projected from the positive electrode plate.

### Formation of Negative Electrode

First, graphite as a negative electrode active material, styrene butadiene rubber as a binder, and carboxymethyl cellulose as a viscosity adjusting agent were mixed at 96:2:2 (mass ratio), and the resultant mixture was dispersed in water to prepare a slurry. The slurry was uniformly applied, by a doctor blade method, to both surfaces of a copper foil serving as a negative electrode core and having a thickness of 10 μm. The slurry applied on the copper foil was dried by heating to form a dry electrode plate having a negative electrode mixture layer formed on the copper foil. The dry electrode plate was compressed by a roller press machine and then cut into predetermined dimensions to form a negative electrode plate having a height of 155 mm, a width of 155 mm, and a thickness of 150 μm. In addition, the negative electrode current collector tab 5 including only a copper foil having a width of 30 mm and a height of 20 mm was projected from the negative electrode plate.

### Formation of Electrode Body

Twenty positive electrode plates and twenty-one negative electrode plates were alternately laminated through polyethylene-made fine porous film separators having a height of 155 mm, a width of 155 mm, and a thickness of 20 μm. The positive electrode current collector tabs 4 are bundled, and the negative electrode current collector tabs 5 are bundled, and the positive electrode terminal 6 including an aluminum plate and the negative electrode terminal 7 including a copper plate are connected to the positive electrode current collector tabs 4 and the negative electrode current collector tabs 5, respectively, by ultrasonic welding. In this way, the laminated electrode body 10 was formed.

### Preparation of Electrolyte

Lithium hexafluorophosphate used as an electrolyte salt was dissolved in a nonaqueous mixed solvent of ethylene carbonate and diethyl carbonate at a volume ratio of 25:75 (25° C., 1 atm) so that the concentration was 1.4 mol/L. Then, vinylene carbonate was mixed at 1% by mass based on the total mass of the nonaqueous solvent, thereby preparing a nonaqueous electrolyte.

### Assembly of Battery

The laminated electrode body 10 is contained in the external body 1, and the weld sealing portion 1′ provided at the peripheral edge of the external body 1 is heat-welded except one side from which the positive electrode terminal 6 and the negative electrode terminal 7 were projected. Then, the nonaqueous electrolyte was injected from the unwelded side, and then, after pressure reduction, the side was heat-welded by the weld sealing portion 1′. In this way, a nonaqueous electrolyte secondary battery with a design capacity of 25 Ah according to Example 1 was formed.

### Example 2

A nonaqueous electrolyte secondary battery according to Example 2 was formed by the same method as in Example 1 except using a positive electrode active material prepared by mixing lithium carbonate so that the final composition of the positive electrode active material had a (total of nickel, cobalt, manganese, and zirconium):lithium molar ratio of 1:1.05.

### Example 3

A nonaqueous electrolyte secondary battery according to Example 3 was formed by the same method as in Example 1 except using a positive electrode active material prepared by mixing lithium carbonate so that the final composition of the positive electrode active material had a (total of nickel, cobalt, manganese, and zirconium):lithium molar ratio of 1:1.15.

### Example 4

A nonaqueous electrolyte secondary battery according to Example 4 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.5:0.4:0.1.

### Example 5

A nonaqueous electrolyte secondary battery according to Example 5 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.4:0.5:0.1.

### Example 6

A nonaqueous electrolyte secondary battery according to Example 6 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.4:0.3:0.3.

### Example 7

A nonaqueous electrolyte secondary battery according to Example 7 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.33:0.34:0.33.

### Example 8

A nonaqueous electrolyte secondary battery according to Example 8 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.4:0.4:0.2.

### Example 9

A nonaqueous electrolyte secondary battery according to Example 9 was formed by the same method as in Example 1 except using a positive electrode active material prepared by mixing zirconium oxide in an amount changed so that the final composition of the positive electrode active material had a (nickel-cobalt-manganese):zirconium molar ratio of 0.990:0.01.

### Example 10

A nonaqueous electrolyte secondary battery according to Example 10 was formed by the same method as in Example 1 except using a positive electrode active material having a particle diameter of 10 μm.

### Example 11

A nonaqueous electrolyte secondary battery according to Example 11 was formed by the same method as in Example 1 except using a positive electrode plate including a positive electrode mixture having an active material filling density of 2.30 g/cm³.

### Example 12

A nonaqueous electrolyte secondary battery according to Example 12 was formed by the same method as in Example 1 except using a positive electrode plate including a positive electrode mixture having an active material filling density of 3.00 g/cm³.

### Example 13

A nonaqueous electrolyte secondary battery according to Example 13 was formed by the same method as in Example 1 except using a positive electrode plate including a positive electrode mixture having an active material filling density of 3.50 g/cm³.

### Example 14

A nonaqueous electrolyte secondary battery according to Example 14 was formed by the same method as in Example 1 except using acetylene black having a BET specific surface area of 25 m²/g as a conductive agent of a positive electrode mixture.

### Example 15

A nonaqueous electrolyte secondary battery according to Example 15 was formed by the same method as in Example 1 except using acetylene black having a BET specific surface area of 50 m²/g as a conductive agent of a positive electrode mixture.

### Example 16

A nonaqueous electrolyte secondary battery according to Example 16 was formed by the same method as in Example 7 except using acetylene black having a BET specific surface area of 25 m²/g as a conductive agent of a positive electrode mixture.

### Example 17

A nonaqueous electrolyte secondary battery according to Example 17 was formed by the same method as in Example 7 except using acetylene black having a BET specific surface area of 50 m²/g as a conductive agent of a positive electrode mixture.

### Example 18

A nonaqueous electrolyte secondary battery according to Example 18 was formed by the same method as in Example 8 except using acetylene black having a BET specific surface area of 25 m²/g as a conductive agent of a positive electrode mixture.

### Example 19

A nonaqueous electrolyte secondary battery according to Example 19 was formed by the same method as in Example 8 except using acetylene black having a BET specific surface area of 50 m²/g as a conductive agent of a positive electrode mixture.

### Example 20

A nonaqueous electrolyte secondary battery according to Example 20 was formed by the same method as in Example 1 except using a positive electrode active material prepared by mixing zirconium oxide and tungsten oxide so that the final composition of the positive electrode active material had a (total of nickel, cobalt, and manganese):zirconium:tungsten molar ratio of 0.99:0.005:0.005.

### Comparative Example 1

A nonaqueous electrolyte secondary battery according to Comparative Example 1 was formed by the same method as in Example 1 except using a positive electrode active material prepared by mixing lithium carbonate so that the final composition of the positive electrode active material had a (total of nickel, cobalt, manganese, and zirconium):lithium molar ratio of 1:1.00.

### Comparative Example 2

A nonaqueous electrolyte secondary battery according to Comparative Example 2 was formed by the same method as in Example 1 except using a positive electrode active material prepared by mixing lithium carbonate so that the final composition of the positive electrode active material had a (total of nickel, cobalt, manganese, and zirconium):lithium molar ratio of 1:1.20.

### Comparative Example 3

A nonaqueous electrolyte secondary battery according to Comparative Example 3 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0:0.5:0.5. Hereinafter, a ratio of 0 represents “not containing the component”.

### Comparative Example 4

A nonaqueous electrolyte secondary battery according to Comparative Example 4 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.6:0.4:0.

### Comparative Example 5

A nonaqueous electrolyte secondary battery according to Comparative Example 5 was formed by the same method as in Example 1 except using a positive electrode active material prepared by using a sulfuric acid solution in which the molar ratio of each metal ion was changed so that the final composition of the positive electrode active material had a nickel:cobalt:manganese molar ratio of 0.5:0:0.5.

### Comparative Example 6

A nonaqueous electrolyte secondary battery according to Comparative Example 6 was formed by the same method as in Example 1 except using a positive electrode active material having a particle diameter of 7 μm and prepared by using a sulfuric acid solution in which the molar ratio of each metal ion was changed so that the final composition of the positive electrode active material had a nickel:cobalt:manganese molar ratio of 0.4:0.6:0.

### Comparative Example 7

A nonaqueous electrolyte secondary battery according to Comparative Example 7 was formed by the same method as in Example 1 except using a positive electrode active material prepared, without mixing zirconium oxide, by using a sulfuric acid solution in which the molar ratio of each metal ion was changed so that the final composition of the positive electrode active material had a nickel:cobalt:manganese molar ratio of 0.33:0.34:0.33.

### Comparative Example 8

A nonaqueous electrolyte secondary battery according to Comparative Example 8 was formed by the same method as in Comparative Example 1 except using a positive electrode active material prepared without mixing zirconium oxide.

### Comparative Example 9

A nonaqueous electrolyte secondary battery according to Comparative Example 9 was formed by the same method as in Example 1 except using a positive electrode active material prepared without mixing zirconium oxide.

### Comparative Example 10

A nonaqueous electrolyte secondary battery according to Comparative Example 10 was formed by the same method as in Example 1 except using a positive electrode active material prepared by mixing zirconium oxide in an amount changed so that the final composition of the positive electrode active material had a (total of nickel, cobalt, and manganese):zirconium molar ratio of 0.950:0.05.

### Comparative Example 11

A nonaqueous electrolyte secondary battery according to Comparative Example 11 was formed by the same method as in Example 1 except using a positive electrode active material having a particle diameter of 15 μm.

### Comparative Example 12

A nonaqueous electrolyte secondary battery according to Comparative Example 12 was formed by the same method as in Example 1 except using a positive electrode plate including a positive electrode mixture having an active material filling density of 3.60 g/cm³.

### Comparative Example 13

A nonaqueous electrolyte secondary battery according to Comparative Example 13 was formed by the same method as in Example 1 except using acetylene black having a BET specific surface area of 70 m²/g as a conductive agent of a positive electrode mixture.

### Comparative Example 14

A nonaqueous electrolyte secondary battery according to Comparative Example 14 was formed by the same method as in Comparative Example 1 except using acetylene black having a BET specific surface area of 70 m²/g as a conductive agent of a positive electrode mixture.

### Comparative Example 15

A nonaqueous electrolyte secondary battery according to Comparative Example 15 was formed by the same method as in Comparative Example 4 except using acetylene black having a BET specific surface area of 70 m²/g as a conductive agent of a positive electrode mixture.

### Comparative Example 16

A nonaqueous electrolyte secondary battery according to Comparative Example 16 was formed by the same method as in Example 7 except using acetylene black having a BET specific surface area of 70 m²/g as a conductive agent of a positive electrode mixture.

### Comparative Example 17

A nonaqueous electrolyte secondary battery according to Comparative Example 17 was formed by the same method as in Example 8 except using acetylene black having a BET specific surface area of 70 m²/g as a conductive agent of a positive electrode mixture.

### Comparative Example 18

A nonaqueous electrolyte secondary battery according to Comparative Example 18 was formed by the same method as in Example 1 except using furnace black having a BET specific surface area of 50 m²/g as a conductive agent of a positive electrode mixture.

### Comparative Example 19

A nonaqueous electrolyte secondary battery according to Comparative Example 19 was formed by the same method as in Example 1 except using a positive electrode active material prepared by mixing aluminum oxide so that the final composition of the positive electrode active material had a (nickel-cobalt-manganese):aluminum molar ratio of 0.995:0.005.

### Comparative Example 20

A nonaqueous electrolyte secondary battery according to Comparative Example 20 was formed by the same method as in Example 1 except using a positive electrode active material prepared by mixing magnesium oxide so that the final composition of the positive electrode active material had a (nickel-cobalt-manganese):aluminum molar ratio of 0.995:0.005.

A charge/discharge cycle test and a high-temperature storage test were performed using each of the nonaqueous electrolyte secondary batteries described above.

### Charge/Discharge Cycle Test

The formed battery was charged with a constant current value of 50 A at 25° C. up to 4.0 V and then charged at a constant voltage of 4.0 V until a charge current value was 0.5 A. Then, the battery was discharged at a current value of 50 A up to 3.0 V. The charge/discharge step was regarded as one cycle, and the step was repeated by 500 cycles. The ratio of discharge capacity at the 500-th cycle to that at the first cycle was regarded as a capacity retention rate (%).

### High-Temperature Storage Test

The formed battery was charged with a constant current value of 25 A at 25° C. up to 4.1 V and then charged at a constant voltage of 4.1 V until a charge current value was 0.5 A. Then, the battery was discharged at a current value of 25 A up to 2.75 V. The discharge capacity in the discharge step was considered as capacity before storage.

Further, the battery was charged with a constant current value of 25 A at 25° C. up to 4.1 V and then charged at a constant voltage of 4.1 V until a charge current value was 0.5 A. Then, the battery was stored in a constant-temperature oven at 60° C. for 100 days. The battery after the completion of storage was allowed to stand until it became 25° C. and then discharged at a current value of 25 A at 250 up to 2.75 V. The discharge capacity in the discharge step was considered as capacity after storage. The ratio of the capacity after storage to the capacity before storage was regarded as a remaining capacity rate (%) after high-temperature storage.

The test results of the examples and comparative examples are summarized in Tables 1 to 4. In the tables, a component not added in the composition of each of the positive electrode active materials is also shown by adding 0.00 or 0.000 to the symbol for the element of the component.

TABLE 1

| | | | Charge/discharge cycle | Remaining capacity rate |
|---|---|---|---|---|
| | Positive electrode active material | Particle | capacity retention rate | after high-temperature |
| | composition | diameter (μm) | (%) | storage (%) |
| Comparative Example 1 | Li_{1.00}(Ni_{0.3}Co_{0.4}Mn_{0.3})_{0.995}Zr_{0.005}O₂ | 8 | 94 | 88 |
| Example 2 | Li_{1.05}(Ni_{0.3}Co_{0.4}Mn_{0.3})_{0.995}Zr_{0.005}O₂ | 8 | 98 | 92 |
| Example 1 | Li_{1.10}(Ni_{0.3}Co_{0.4}Mn_{0.3})_{0.995}Zr_{0.005}O₂ | 8 | 98 | 92 |
| Example 3 | Li_{1.15}(Ni_{0.3}Co_{0.4}Mn_{0.3})_{0.995}Zr_{0.005}O₂ | 8 | 98 | 92 |
| Comparative Example 2 | Li_{1.20}(Ni_{0.3}Co_{0.4}Mn_{0.3})_{0.995}Zr_{0.005}O₂ | 8 | 94 | 86 |
| Comparative Example 3 | Li_{1.10}(Ni_{0.0}Co_{0.5}Mn_{0.5})_{0.995}Zr_{0.005}O₂ | 8 | 92 | 87 |
| Example 4 | Li_{1.10}(Ni_{0.5}Co_{0.4}Mn_{0.1})_{0.995}Zr_{0.005}O₂ | 8 | 98 | 91 |
| Comparative Example 4 | Li_{1.10}(Ni_{0.6}Co_{0.4}Mn_{0.0})_{0.995}Zr_{0.005}O₂ | 8 | 94 | 86 |
| Comparative Example 5 | Li_{1.10}(Ni_{0.5}Co_{0.0}Mn_{0.5})_{0.995}Zr_{0.005}O₂ | 8 | 92 | 87 |
| Example 5 | Li_{1.10}(Ni_{0.4}Co_{0.5}Mn_{0.1})_{0.995}Zr_{0.005}O₂ | 8 | 97 | 91 |
| Example 6 | Li_{1.10}(Ni_{0.4}Co_{0.3}Mn_{0.3})_{0.995}Zr_{0.005}O₂ | 8 | 98 | 93 |
| Comparative Example 6 | Li_{1.10}(Ni_{0.4}Co_{0.6}Mn_{0.0})_{0.995}Zr_{0.005}O₂ | 7 | 94 | 88 |
| Example 7 | Li_{1.10}(Ni_{0.33}Co_{0.34}Mn_{0.33})_{0.995}Zr_{0.005}O₂ | 8 | 98 | 92 |
| Example 8 | Li_{1.10}(Ni_{0.4}Co_{0.4}Mn_{0.2})_{0.995}Zr_{0.005}O₂ | 8 | 97 | 93 |
| Comparative Example 7 | Li_{1.10}(Ni_{0.33}Co_{0.34}Mn_{0.33})_{1.000}Zr_{0.000}O₂ | 8 | 91 | 87 |
| Comparative Example 8 | Li_{1.00}(Ni_{0.3}Co_{0.4}Mn_{0.3})_{1.000}Zr_{0.000}O₂ | 8 | 92 | 87 |
| Comparative Example 9 | Li_{1.10}(Ni_{0.3}Co_{0.4}Mn_{0.3})_{1.000}Zr_{0.000}O₂ | 8 | 92 | 87 |
| Example 9 | Li_{1.10}(Ni_{0.3}Co_{0.4}Mn_{0.3})_{0.990}Zr_{0.01}O₂ | 8 | 98 | 92 |
| Comparative Example 10 | Li_{1.10}(Ni_{0.3}Co_{0.4}Mn_{0.3})_{0.950}Zr_{0.05}O₂ | 8 | 94 | 87 |
| Example 10 | Li_{1.10}(Ni_{0.3}Co_{0.4}Mn_{0.3})_{0.995}Zr_{0.005}O₂ | 10 | 98 | 92 |
| Comparative Example 11 | Li_{1.10}(Ni_{0.3}Co_{0.4}Mn_{0.3})_{0.995}Zr_{0.005}O₂ | 15 | 93 | 87 |

Table 1 summarizes the compositions and the particle diameters of the positive electrode active materials and indicates the following. That is, comparison between Examples 1 to 3 and Comparative Examples 1 and 2 shows that when the conductive agent added to the positive electrode mixture has a specific surface area of 40 m²/g and the positive electrode mixture has an active material filling density of 3.25 g/cm³, the positive electrode active material composition having a (total of nickel, cobalt, manganese, and zirconium):lithium molar ratio of 1:1.05 to 1:1.15 is good in both the charge/discharge cycle capacity retention rate and the remaining capacity rate after high-temperature storage.

Comparative Examples 3, 4, 5, and 6 indicate that when the positive electrode active material lacks any one component of nickel, cobalt, and manganese, even with the addition of zirconium, the charge/discharge cycle capacity retention rate and the remaining capacity rate after high-temperature storage tend to decrease. In addition, Comparative Examples 7, 8, and 9 indicate that even when the ratio between nickel, cobalt, and manganese is within the range of the present invention, without the addition of zirconium, the charge/discharge cycle capacity retention rate and the remaining capacity rate after high-temperature storage tend to decrease. Further, Comparative Example 10 indicates that even when the amount of zirconium exceeds the range of the present invention, the charge/discharge cycle capacity retention rate and the remaining capacity rate after high-temperature storage tend to decrease.

Further, comparison between Examples 2 and 10 and Comparative Example 11 shows that even when the composition of positive electrode active material falls in the range of the present invention, with the particle diameter exceeding 10 μm, the charge/discharge cycle capacity retention rate and the remaining capacity rate after high-temperature storage tend to decrease.

Therefore, it is found that when the positive electrode active material is represented by Liₐ(Ni_{b}Co_{c}Mn_{d})₁₋ₓZrₓM_{y}O₂ (in Table 1, y=0), wherein a=1.10±0.05, 0.3≦b≦0.5, 0.3≦c≦0.5, b+c+d=1, and 0.001≦x≦0.01, the positive electrode active material having a particle diameter of 10 μm or less is good in the charge/discharge cycle capacity retention rate and the remaining capacity rate after high-temperature storage.

In addition, an excessively small particle diameter decreases the filling property of the positive electrode mixture in the positive electrode plate and causes difficulty in filling to a desired density, and thus the particle diameter is preferably 4 μm or more.

TABLE 2

| | | | | | Remaining capacity |
|---|---|---|---|---|---|
| | | | | Charge/discharge | rate after high- |
| | Positive electrode active material | Particle | Active material filling | cycle capacity | temperature |
| | composition | diameter (μm) | density (g/cm³) | retention rate (%) | storage (%) |
| Comparative | Li_{1.10}(Ni_{0.3}Co_{0.4}Mn_{0.3})_{1.000}Zr_{0.000}O₂ | 8 | 3.25 | 92 | 87 |
| Example 9 | | | | | |
| Example 11 | Li_{1.10}(Ni_{0.3}Co_{0.4}Mn_{0.3})_{0.995}Zr_{0.005}O₂ | 8 | 2.30 | 95 | 89 |
| Example 12 | Li_{1.10}(Ni_{0.3}Co_{0.4}Mn_{0.3})_{0.995}Zr_{0.005}O₂ | 8 | 3.00 | 97 | 91 |
| Example 1 | Li_{1.10}(Ni_{0.3}Co_{0.4}Mn_{0.3})_{0.995}Zr_{0.005}O₂ | 8 | 3.25 | 98 | 92 |
| Example 13 | Li_{1.10}(Ni_{0.3}Co_{0.4}Mn_{0.3})_{0.995}Zr_{0.005}O₂ | 8 | 3.50 | 98 | 91 |
| Comparative | Li_{1.10}(Ni_{0.3}Co_{0.4}Mn_{0.3})_{0.995}Zr_{0.005}O₂ | 8 | 3.60 | 94 | 88 |
| Example 12 | | | | | |

Table 2 summarizes the active material filling densities in the positive electrode mixtures and shows the following. That is, when the positive electrode active material having a composition within the range of the present invention is used, an active material filling density of 3.50 g/cm³ or less exhibits a good charge/discharge cycle capacity retention rate and good remaining capacity rate after high-temperature storage. However, with increasing filling density, the charge/discharge cycle capacity retention rate and the remaining capacity rate after high-temperature storage tend to decrease. Also, with decreasing filling density, the charge/discharge cycle capacity retention rate and the remaining capacity rate after high-temperature storage tend to slightly decrease. Therefore, the filling density is preferably 3.0 g/cm³ or more.

Also, Comparative Example 9 indicates that even with a filling density of 3.50 g/cm³ or less, when zirconium is not added to the positive electrode active material, the charge/discharge cycle capacity retention rate and the remaining capacity rate after high-temperature storage tend to decrease.

TABLE 3

| | | Conductive agent | | | Remaining |
|---|---|---|---|---|---|
| | | | BET specific | Charge/discharge | capacity rate after |
| | Positive electrode active material | | surface area | cycle capacity | high-temperature |
| | composition | Type | (m²/g) | retention rate (%) | storage (%) |
| Example 14 | Li_{1.10}(Ni_{0.3}Co_{0.4}Mn_{0.3})_{0.995}Zr_{0.005}O₂ | Acetylene black | 25 | 97 | 92 |
| Example 1 | Li_{1.10}(Ni_{0.3}Co_{0.4}Mn_{0.3})_{0.995}Zr_{0.005}O₂ | Acetylene black | 40 | 98 | 92 |
| Example 15 | Li_{1.10}(Ni_{0.3}Co_{0.4}Mn_{0.3})_{0.995}Zr_{0.005}O₂ | Acetylene black | 50 | 98 | 92 |
| Comparative | Li_{1.10}(Ni_{0.3}Co_{0.4}Mn_{0.3})_{0.995}Zr_{0.005}O₂ | Acetylene black | 70 | 94 | 88 |
| Example 13 | | | | | |
| Comparative | Li_{1.00}(Ni_{0.3}Co_{0.4}Mn_{0.3})_{0.995}Zr_{0.005}O₂ | Acetylene black | 40 | 94 | 88 |
| Example 1 | | | | | |
| Comparative | Li_{1.00}(Ni_{0.3}Co_{0.4}Mn_{0.3})_{0.995}Zr_{0.005}O₂ | Acetylene black | 70 | 94 | 88 |
| Example 14 | | | | | |
| Comparative | Li_{1.10}(Ni_{0.6}Co_{0.4}Mn_{0.0})_{0.995}Zr_{0.005}O₂ | Acetylene black | 40 | 94 | 86 |
| Example 4 | | | | | |
| Comparative | Li_{1.10}(Ni_{0.6}Co_{0.4}Mn_{0.0})_{0.995}Zr_{0.005}O₂ | Acetylene black | 70 | 94 | 87 |
| Example 15 | | | | | |
| Example 16 | Li_{1.10}(Ni_{0.33}Co_{0.34}Mn_{0.33})_{0.995}Zr_{0.005}O₂ | Acetylene black | 25 | 98 | 92 |
| Example 7 | Li_{1.10}(Ni_{0.33}Co_{0.34}Mn_{0.33})_{0.995}Zr_{0.005}O₂ | Acetylene black | 40 | 98 | 92 |
| Example 17 | Li_{1.10}(Ni_{0.33}Co_{0.34}Mn_{0.33})_{0.995}Zr_{0.005}O₂ | Acetylene black | 50 | 97 | 91 |
| Comparative | Li_{1.10}(Ni_{0.33}Co_{0.34}Mn_{0.33})_{0.995}Zr_{0.005}O₂ | Acetylene black | 70 | 94 | 87 |
| Example 16 | | | | | |
| Example 18 | Li_{1.10}(Ni_{0.4}Co_{0.4}Mn_{0.2})_{0.995}Zr_{0.005}O₂ | Acetylene black | 25 | 97 | 92 |
| Example 8 | Li_{1.10}(Ni_{0.4}Co_{0.4}Mn_{0.2})_{0.995}Zr_{0.005}O₂ | Acetylene black | 40 | 97 | 93 |
| Example 19 | Li_{1.10}(Ni_{0.4}Co_{0.4}Mn_{0.2})_{0.995}Zr_{0.005}O₂ | Acetylene black | 50 | 98 | 92 |
| Comparative | Li_{1.10}(Ni_{0.4}Co_{0.4}Mn_{0.2})_{0.995}Zr_{0.005}O₂ | Acetylene black | 70 | 93 | 86 |
| Example 17 | | | | | |
| Comparative | Li_{1.10}(Ni_{0.3}Co_{0.4}Mn_{0.3})_{0.995}Zr_{0.005}O₂ | Furnace black | 50 | 92 | 87 |
| Example 18 | | | | | |

Table 3 summarizes the conductive agents and shows the following. Comparison between Examples 1, 14, and 15 and Comparative Example 13, comparison between Examples 7, 16, and 17 and Comparative Example 16, and comparison between Examples 8, 18, and 19 and Comparative Example 17 indicate that when the BET specific surface area of the conductive agent is increased to 70 m²/g, the charge/discharge cycle capacity retention rate and the remaining capacity rate after high-temperature storage tend to decrease. Also, comparison between Example 19 and Comparative Example 18 indicates that even with the same specific surface area, furnace black used as the conductive agent degrades the characteristics. It is considered that the conductive state in the positive electrode mixture varies with the type of carbon black. Further, comparison between Comparative Example 1 and Comparative Example 14 and comparison between Comparative Example 4 and Comparative Example 15 indicate that when the composition of the positive electrode active material is beyond the range of the present invention, even with the conductive agent within the range of the present invention, the battery characteristics are not improved, and thus the conductive agent according to the present invention has a specific effect.

Therefore, it is necessary to use acetylene black having a BET specific surface area of 25 to 50 cm²/g as the conductive agent.

TABLE 4
Table 4

| | | | Remaining capacity |
|---|---|---|---|
| | | Charge/discharge | rate after |
| | Positive electrode active material | cycle capacity | high-temperature |
| | composition | retention rate (%) | storage (%) |
| Example 1 | Li_{1.10}(Ni_{0.3}Co_{0.4}Mn_{0.3})_{0.995}Zr_{0.005}O₂ | 98 | 92 |
| Example 20 | Li_{1.10}(Ni_{0.3}Co_{0.4}Mn_{0.3})_{0.98}Zr_{0.005}W_{0.005}O₂ | 98 | 92 |
| Comparative | Li_{1.10}(Ni_{0.3}Co_{0.4}Mn_{0.3})_{0.995}Al_{0.005}O₂ | 92 | 88 |
| Example 19 | | | |
| Comparative | Li_{1.10}(Ni_{0.3}Co_{0.4}Mn_{0.3})_{0.995}Mg_{0.005}O₂ | 92 | 87 |
| Example 20 | | | |

Table 4 summarizes the elements added to the positive electrode active material and shows the following. That is, comparison between Example 1 and Comparative Examples 19 and 20 indicates that the positive electrode active material essentially contains zirconium. On the other hand, Example 20 indicates that when the positive electrode active material contains zirconium, even the positive electrode active material further containing an additional element such as tungsten maintains good characteristics. Besides tungsten, titanium, niobium, molybdenum, zinc, aluminum, tin, magnesium, calcium, or strontium can be preferably used as the additional element like tungsten. In addition, the amount of the additional element added is preferably a molar ratio of 0.1 or less.

### INDUSTRIAL APPLICABILITY

According to the present invention, a nonaqueous electrolyte secondary battery having a good charge/discharge cycle capacity retention rate and remaining capacity rate after high-temperature storage can be provided, and thus has large industrial applicability.

### REFERENCE SIGNS LIST

10 laminated electrode body
20 nonaqueous electrolyte secondary battery

1: A nonaqueous electrolyte secondary battery comprising a positive electrode containing a positive electrode mixture, a negative electrode, a separator which insulates between the positive electrode and the negative electrode, and a nonaqueous electrolyte,
wherein the positive electrode mixture contains a positive electrode active material having a particle diameter of 10 μm or less and containing a main material represented by a composition formula Liₐ(Ni_{b}Co_{c}Mn_{d})_{1-x-y}ZrₓM_{y}O₂ (wherein a=1.10±0.05, 0.3≦b≦0.5, 0.3≦c≦0.5, b+c+d=1, 0.001≦x≦0.01, 0≦y≦0.1, and M is an element selected from Ti, Nb, Mo, Zn, Al, Sn, Mg, Ca, Sr, and W), and
acetylene black as a conductive agent which has a specific surface area of 25 m²/g or more and 50 m²/g or less determined by a BET method; and
the filling density of the positive electrode active material is 3.5 g/cm³ or less.

2: The nonaqueous electrolyte secondary battery according to claim 1, wherein the filling density of the positive electrode active material is 3.0 g/cm³ or more.

3: The nonaqueous electrolyte secondary battery according to claim 1, wherein the positive electrode and the negative electrode both have a flat-plate shape, and a plurality of flat-plate-shaped positive electrodes and a plurality of flat-plate-shaped negative electrodes are alternately laminated through separators.

4: The nonaqueous electrolyte secondary battery according to claim 2, wherein the positive electrode and the negative electrode both have a flat-plate shape, and a plurality of flat-plate-shaped positive electrodes and a plurality of flat-plate-shaped negative electrodes are alternately laminated through separators.
